(19) United States
(12) Patent Application Publication
(10) Pub. No.: US 2024/0329570 A1
(43) Pub. Date: Oct. 3, 2024

(54) HOLDING DEVICE, FIXING DEVICE, AND IMAGE FORMING SYSTEM

(71) Applicant: FUJIFILM Business Innovation Corp., Tokyo (JP)

(72) Inventors: Kosuke YAMADA, Kanagawa (JP); Takayuki YAMASHITA, Kanagawa (JP); Yoshiyuki TOMINAGA, Kanagawa (JP)

(73) Assignee: FUJIFILM Business Innovation Corp., Tokyo (JP)

(21) Appl. No.: 18/360,396

(22) Filed: Jul. 27, 2023

(30) Foreign Application Priority Data
Mar. 27, 2023 (JP) 2023-050310

(51) Int. Cl. G03G 15/20

(52) U.S. Cl. CPC G03G 15/2007; G03G 15/2028; G03G 2215/00687

(57) ABSTRACT

A holding device includes: a base; a support member that is attached to the base and supports an object having a three-dimensional shape, to which a toner image has been transferred, in a state in which the object is not in contact with an upper surface of the base; and a reflecting member that is attached to the base, that reflects light emitted from a light source provided above the object in a state of being supported by the support member, and that irradiates at least a lower surface side of the object.

### CROSS-REFERENCE TO RELATED APPLICATIONS

This application is based on and claims priority under 35 USC 119 from Japanese Patent Application No. 2023-050310 filed Mar. 27, 2023.

### BACKGROUND

### (i) Technical Field

The present disclosure relates to a holding device, a fixing device, and an image forming system.

### (ii) Related Art

In recent years, some image forming apparatuses can transfer a toner image to a surface of an object having a three-dimensional shape such as a cylinder. Currently, a non-contact heating method is used to fix a toner image to an object having a three-dimensional shape. In a heating method of this type, for example, infrared rays or far-infrared rays are used. This heating method is also called a heat-radiation method. (See, for example, Japanese Patent No. 6900650.)

### SUMMARY

Infrared rays or the like, which are a type of electromagnetic waves, propagate linearly. Therefore, if the positional relationship between a light source of infrared rays or the like and an object having a three-dimensional shape is fixed, some parts of the object are not irradiated while the other parts are irradiated with infrared rays or the like. As a result, increase in the temperature of the parts that are not irradiated with infrared rays or the like may be insufficient, and fixing failure may occur in a toner image. Although this problem can be addressed, for example, by changing the position of the object having a three-dimensional shape during irradiation with infrared rays or the like, to do so, it is necessary, for example, to design and set a new mechanism.

Aspects of non-limiting embodiments of the present disclosure relate to reducing fixing failure with fewer changes than in a case of providing a new mechanism for rotating, in a heating chamber, the position of an object having a three-dimensional shape to which a toner image has been transferred.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided a holding device including: a base; a support member that is attached to the base and supports an object having a three-dimensional shape, to which a toner image has been transferred, in a state in which the object is not in contact with an upper surface of the base; and a reflecting member that is attached to the base, that reflects light emitted from a light source provided above the object in a state of being supported by the support member, and that irradiates at least a lower surface side of the object.

### BRIEF DESCRIPTION OF THE DRAWINGS

Exemplary embodiments of the present disclosure will be described in detail based on the following figures, wherein:

FIG. 1 illustrates a schematic configuration of an image forming system according to a first exemplary embodiment;

FIG. 2 illustrates an example of the configuration of a transfer device used in the first exemplary embodiment;

FIG. 3 illustrates an example of the configuration of a fixing device used in the first exemplary embodiment;

FIG. 4 illustrates an example of a jig used in the first exemplary embodiment;

FIGS. 5A and 5B illustrate an example of attachment of a recording medium to the jig in the first exemplary embodiment, FIG. 5A is a perspective view illustrating an attachment state of the recording medium, and FIG. 5B is a side view illustrating the attachment state of the recording medium;

FIG. 6 illustrates the height relationship between a recording medium in a state of being supported by a support member and a reflecting mirror;

FIG. 7 illustrates the paths of far-infrared rays emitted from a far-infrared unit;

FIG. 8 is a graph representing temperatures measured at each measurement position of a recording medium;

FIG. 9 illustrates the measurement positions where the temperatures are measured;

FIG. 10 illustrates an example of a jig used in a second exemplary embodiment;

FIG. 11 illustrates another configuration example of the fixing device; and

FIG. 12 illustrates a schematic configuration of an image forming system according to another exemplary embodiment.

### DETAILED DESCRIPTION

Hereafter, exemplary embodiments of the present disclosure will be described with reference to the drawings.

### First Exemplary Embodiment

### System Configuration

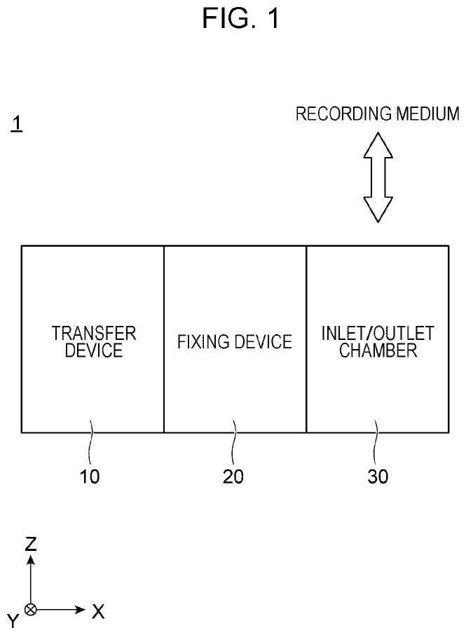

FIG. 1 illustrates a schematic configuration of an image forming system according to a first exemplary embodiment.

An image forming system 1 illustrated in FIG. 1 includes a transfer device 10 that transfers a toner image to a cylindrical surface of a substantially cylindrical recording medium, a fixing device 20 that fixes the transferred toner image to the cylindrical surface of the recording medium, and an inlet/outlet chamber 30.

In the case of the present exemplary embodiment, it is assumed that the recording medium is, for example, an aluminum can, a steel can, or the like. An aluminum can, a steel can, or the like is an example of “an object having a three-dimensional shape, to which a toner image has been transferred”.

The transfer device 10, the fixing device 20, and the inlet/outlet chamber 30 according to the present exemplary embodiment each have an independent housing.

In the present exemplary embodiment, the transfer device 10, the fixing device 20, and the inlet/outlet chamber 30 are coupled to each other to form the image forming system 1. However, the image forming system 1 may be configured as one system in which the transfer device 10, the fixing device 20, and the inlet/outlet chamber 30 are integrated.

The inner space of the transfer device 10 and the inner space of the fixing device 20 are coupled to each other through openings formed in side surfaces of the housings. Likewise, the inner space of the fixing device 20 and the inner space of the inlet/outlet chamber 30 are coupled to each other through openings formed in side surfaces of the housings. That is, the inner space of the transfer device 10, the inner space of the fixing device 20, and the inner space of the inlet/outlet chamber 30 are coupled to each other to form one inner space. Hereafter, the inner spaces coupled to each other will be referred to as the inner space of the image forming system 1.

In the inner space of the image forming system 1, a transport rail (not shown) is attached in such a way as to extend across the transfer device 10, the fixing device 20, and the inlet/outlet chamber 30. The recording medium described above is transported along the transport rail here.

Dimension in the Z-axis direction in the figures will be referred to as “height”, and transportation of a recording medium in the Z-axis direction will be referred to as “raising/lowering”. Transportation in the X-axis direction will be referred to as “horizontal movement”. A plane defined by the X axis and the Y axis is parallel to a floor surface.

The transfer device 10 is a device that transfers an image (hereafter, referred to as “toner image”) formed of toner or powder particles (hereafter, referred to as “toner or the like”) to a recording medium. That is, the transfer device 10 in the present exemplary embodiment transfers an image by using an electrophotographic method.

The fixing device 20 is a device that fixes a toner image to a surface of the recording medium by using a non-contact heating method. In the present exemplary embodiment, the recording medium and the toner are heated by using far-infrared rays (FIR).

The inlet/outlet chamber 30 is a box-shaped housing that is used to transport a recording medium into and out of the image forming system 1. In the case of FIG. 1, in an upper surface of the inlet/outlet chamber 30, an opening for transporting a recording medium M into and out of the image forming system 1 is provided. A recording medium transported into the inlet/outlet chamber 30 passes through the fixing device 20 and is transported to the transfer device 10. When the recording medium is transported to a transfer start position, the transfer device 10 starts transfer of a toner image. When transfer of the toner image to the recording medium is finished, the recording medium is transported from the transfer device 10 to the fixing device 20. The fixing device 20 heats the recording medium, to which the toner image has been transferred, for a predetermined time to fix the toner image to the recording medium. The recording medium, to which the toner image has been fixed, is transported from the fixing device 20 to the inlet/outlet chamber 30, and then is discharged to the outer space.

### Configuration of Transfer Device

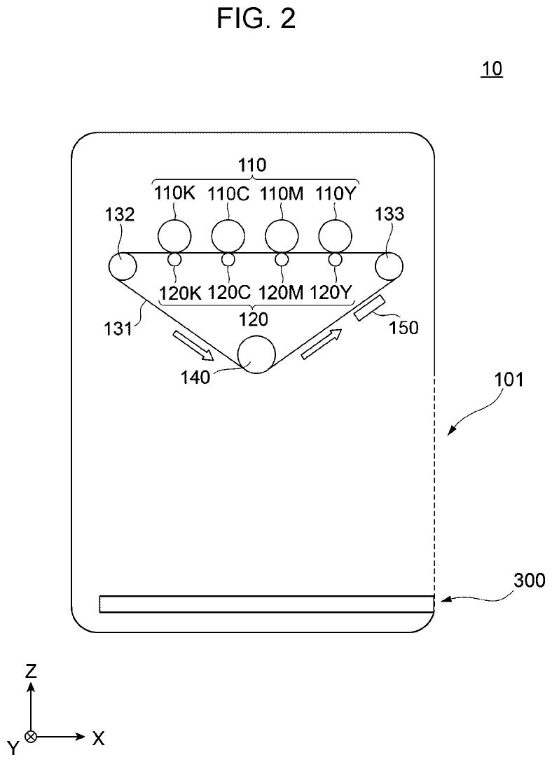

FIG. 2 illustrates an example of the configuration of the transfer device 10 used in the first exemplary embodiment.

An opening 101 used for coupling with the inner space of the fixing device 20 is provided in a side surface of the housing of the transfer device 10.

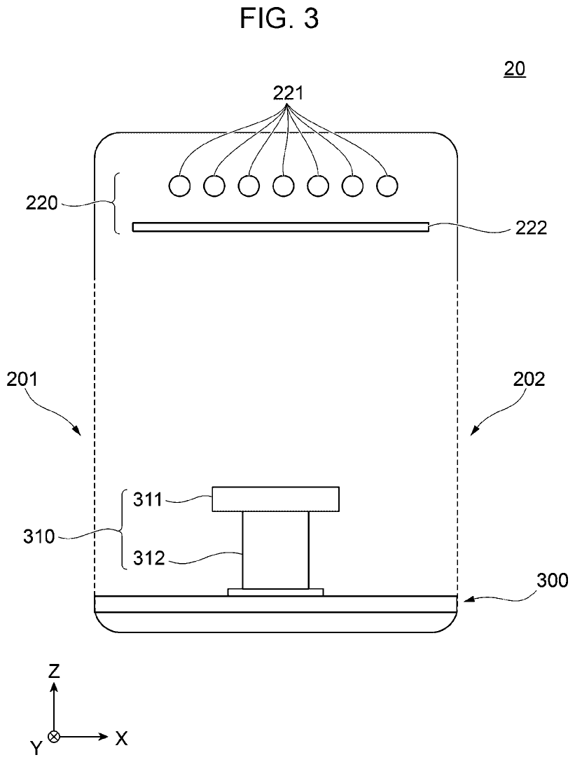

A transport rail 300 for transporting a transport mechanism 310 described below (see FIG. 3) is attached to a lower surface side of the transfer device 10.

A developing device 110, a first-transfer roller 120, and an intermediate transfer belt 131 are provided in an upper space of the transfer device 10. The intermediate transfer belt 131 is transported in a circulating manner in a state in which the intermediate transfer belt 131 is looped over driving rollers 132 and 133 and a backup roller 140. The intermediate transfer belt 131 is an example of a transfer belt.

In addition, a cleaning device 150 is provided in the transfer device 10 to remove, from the intermediate transfer belt 131, toner particles that remain on the intermediate transfer belt 131 after passing the transfer position.

The developing device 110 is a unit that forms an electrostatic latent image on a photoconductor and develops the electrostatic latent image into a toner image by causing charged toner particles to adhere to the electrostatic latent image on the photoconductor. The developing device 110 illustrated in FIG. 2 has four subunits corresponding to four colors, which are yellow, magenta, cyan, and black.

In FIG. 2, symbols Y, M, C, and K representing the colors are attached to the subunits corresponding to the four colors, which are yellow, magenta, cyan, and black.

The first-transfer roller 120 is used to transfer an image formed by the developing device 110 to the intermediate transfer belt 131. The transfer performed by the first-transfer roller 120 is called “first transfer”.

The first-transfer roller 120 is disposed at a position facing the developing device 110 with the intermediate transfer belt 131 therebetween and causes an outer peripheral surface of the intermediate transfer belt 131 to contact the developing device 110.

The first-transfer roller 120 is provided for each of the developing devices 110Y, 110M, 110C, and 110K. In FIG. 2, the first-transfer rollers 120 corresponding to the four colors are denoted as 120Y, 120M, 120C, and 120K.

In the case of FIG. 2, the intermediate transfer belt 131 is moved in the direction of arrows (that is, the counterclockwise direction). The intermediate transfer belt 131 is moved, for example, by one or both of the driving rollers 132 and 133.

In the case of FIG. 2, toner images are first-transferred to the outer peripheral surface of the intermediate transfer belt 131. That is, toner images corresponding to the four colors are held on the intermediate transfer belt 131. Hereafter, the outer peripheral surface of the intermediate transfer belt 131 will be referred to as “transfer surface”.

In the configuration illustrated in FIG. 2, yellow, magenta, cyan, and black are stacked on the transfer surface of the intermediate transfer belt 131 sequentially from the lower layer. That is, a multicolor toner image is held on the transfer surface.

The backup roller 140 causes the transfer surface of the intermediate transfer belt 131 to contact the recording medium, and causes the toner image held on the transfer surface to be transferred to a surface of the recording medium. The transfer performed by the backup roller 140 is called “second transfer”.

In the second transfer, a predetermined voltage is applied to the backup roller 140. Due to application of the voltage, an electric field (hereafter, referred to as “transfer electric field”) is generated in the backup roller 140 and the recording medium, and a toner image formed of charged toner is transferred to the surface of the recording medium.

In order to transfer the image from the intermediate transfer belt 131 to the recording medium in this way, it is necessary that an electric current flows from the backup roller 140 to the recording medium through the intermediate transfer belt 131.

In the case of the present exemplary embodiment, since the recording medium is an aluminum can, a steel can, or the like, an electric current flows to the surface of the recording medium due to generation of the transfer electric field, and the toner image is transferred.

The cleaning device 150 is provided between the transfer position and the developing device 110Y located downstream of the transfer position. In other words, the cleaning device 150 is provided at a position that is downstream of the transfer position and upstream of the developing device 110Y.

As the cleaning device 150 removes remaining toner, preparation of the next transfer cycle is complete. That is, it becomes possible to transfer a new image to the transfer surface. Configuration of Fixing Device

FIG. 3 illustrates an example of the configuration of the fixing device 20 used in the first exemplary embodiment.

An opening 201 used for coupling with the inner space of the transfer device 10 and an opening 202 used for coupling with the inlet/outlet chamber 30 are provided in side surfaces of the fixing device 20.

A far-infrared unit 220 that emits far-infrared rays is disposed in an upper space of the fixing device 20, The far-infrared unit 220 is an example of a light source in a broad sense. The far-infrared unit 220 can be called an example of a heat source.

The far-infrared unit 220 includes plural infrared lamps 221 and a black plate 222. Each of the infrared lamps 221 is a light source in a narrow sense.

The black plate 222 is a member that absorbs infrared rays and emits far-infrared rays. The black plate 222 is made of, for example, ceramics. The black plate 222 combined with the infrared lamps 221 is a light source in a broad sense.

In the case of the present exemplary embodiment, a toner image melts at about 95° C. to become fixed to the surface of a recording medium.

The transport rail 300 is attached between the opening 201 and 202. The transport mechanism 310 is attached to the transport rail 300, and transportation of a recording medium is realized by the transport mechanism 310.

The transport mechanism 310 includes a transport table 311 and a raising/lowering mechanism 312. An upper end portion the raising/lowering mechanism 312 is attached to a bottom surface of the transport table 311. A lower end portion of the raising/lowering mechanism 312 is attached in such a way as to be movable along the transport rail 300 (that is, movable in the horizontal direction).

The horizontal movement of the raising/lowering mechanism 312 may be realized by using, for example, a self-propelling mechanism provided in the raising/lowering mechanism 312, or may be realized by traction or the like by a motor or another drive mechanism provided on the transport rail 300 side.

Raising/lowering of the transport table 311 by the raising/lowering mechanism 312 may be realized by control by a processor (not shown), or may be realized manually. The processor is provided at an appropriate position in the image forming system 1. A ROM (Read Only Memory), a RAM (Random Access Memory), an auxiliary storage device, and the like, which are necessary for the processor to execute a program, are also provided at appropriate positions in the image forming system 1.

It is also possible to directly attach a recording medium and to attach a jig (not shown) to an upper surface of the transport table 311 (hereafter, referred to as “an attachment surface”). The jig can be attached to and removed from the attachment surface of the transport table 311.

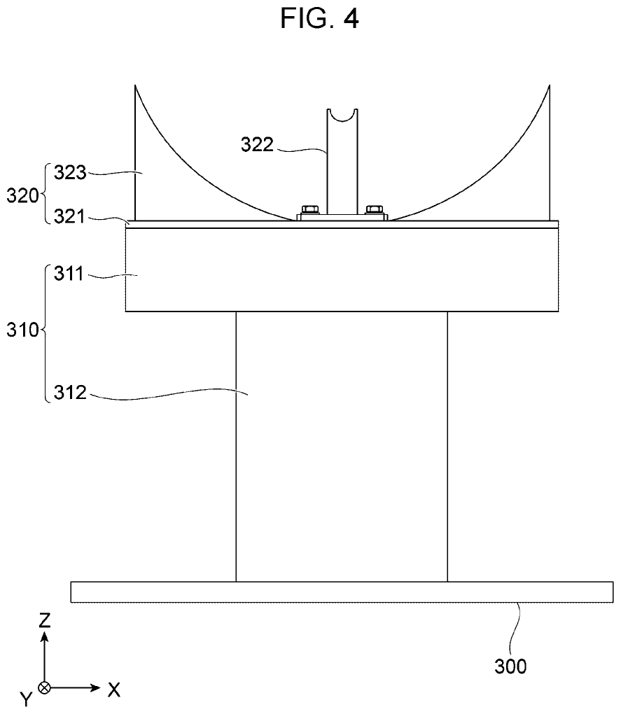

FIG. 4 illustrates an example of a jig 320 used in the first exemplary embodiment. Elements in FIG. 4 corresponding to those in FIG. 3 are denoted by corresponding numerals. The jig 320 here is an example of a holding device.

The jig 320 illustrated in FIG. 4 includes a base 321, a support member 322, and a reflecting mirror 323.

The base 321 is a flat plate-shaped member removably attached to the attachment surface of the transport table 311.

The support member 322 is a member for supporting a recording medium in a state in which the recording medium is not in contact with an upper surface of the base 321, and is attached to the upper surface of the base 321.

In the case of the present exemplary embodiment, two support members 322 are used. The two support members 322 are attached to two end positions of the base 321 in the Y-axis direction. The distance between the two support members 322 is designed in accordance with the dimensions of the recording medium. In an upper end surface of the support member 322 illustrated in FIG. 4, a groove for rotatably supporting a rotation shaft of another jig to be attached to a recording medium is provided. In the case of FIG. 4, the sectional shape of the groove cut along the XZ plane is substantially U-shaped or substantially semicircular.

The support member 322 illustrated in FIG. 4 is a cylindrical member and is attached to the upper surface of the base 321 perpendicularly (that is, in the Z-axis direction).

In the case of FIG. 4, the support member 322 is screwed to the base 321. However, the support member 322 may be integrally formed with the base 321.

The reflecting mirror 323 is a concave mirror attached to the upper surface of the base 321. The reflecting mirror 323 is an example of a reflecting member that reflects far-infrared rays emitted from the far-infrared unit 220 (see FIG. 3).

The reflecting surface of the reflecting mirror 323 is designed in a shape such that it is possible to irradiate at least the lower surface side of a recording medium in a state of being supported by the support member 322 with far-infrared rays reflected by the reflecting surface.

In the case of the present exemplary embodiment, the lower surface side of a recording medium having a cylindrical shape refers to a portion of the outer peripheral surface of the recording medium in a state of being supported by the support member 322, the portion being located below the height position of the rotational symmetry axis of the recording medium. However, the lower surface side may be defined as a portion of the outer peripheral surface of a recording medium, the portion not being directly irradiated with far-infrared rays emitted from the far-infrared unit 220.

The reflecting surface of the reflecting mirror 323 in the present exemplary embodiment is designed so that it is possible to irradiate not only the lower surface side but also a part of a side surface and a part of an upper surface of a recording medium in a state of being supported by the support member 322 with far-infrared rays reflected by the reflecting surface. Here, the upper surface of a recording medium refers a portion of the recording medium in a state of being supported by the jig 320, the portion being above the height of the rotational symmetry axis of the recording medium; and a side surface of a recording medium refers a portion of the recording medium in a state of being supported by the jig 320, the portion being in the vicinity of the height of the rotational symmetry axis of the recording medium. The side surface of a recording medium may include a portion below the height of the rotational symmetry axis of the recording medium as long as the portion is in the vicinity of the height of the rotational symmetry axis of the recording medium.

The reflecting surface of the reflecting mirror 323 may be formed to have a single curvature or may have plural curvatures.

The phrase “have plural curvature” has a meaning that either of the reflecting surfaces of the reflecting mirror 323 with respect to the support member 322 includes plural curved surfaces having different curvatures. For example, if two curvatures are to be used, the radius of curvature of the upper side of the reflecting surface may be made longer than the radius of curvature of the lower side of the reflecting surface.

In the present exemplary embodiment, it is assumed that the sectional shape of the reflecting surface of the reflecting mirror 323 cut along the XZ plane is entirely represented by curved lines, but the sectional shape may have a composite structure of plural straight-line portions. In other words, the reflecting mirror 323 may be an aggregate of plural flat reflecting surfaces. Further alternatively, the reflecting mirror 323 may have a composite structure of linear portions and curved portions.

For example, aluminum is used for the reflecting surface of the reflecting mirror 323. Aluminum has characteristics of reflecting far-infrared rays.

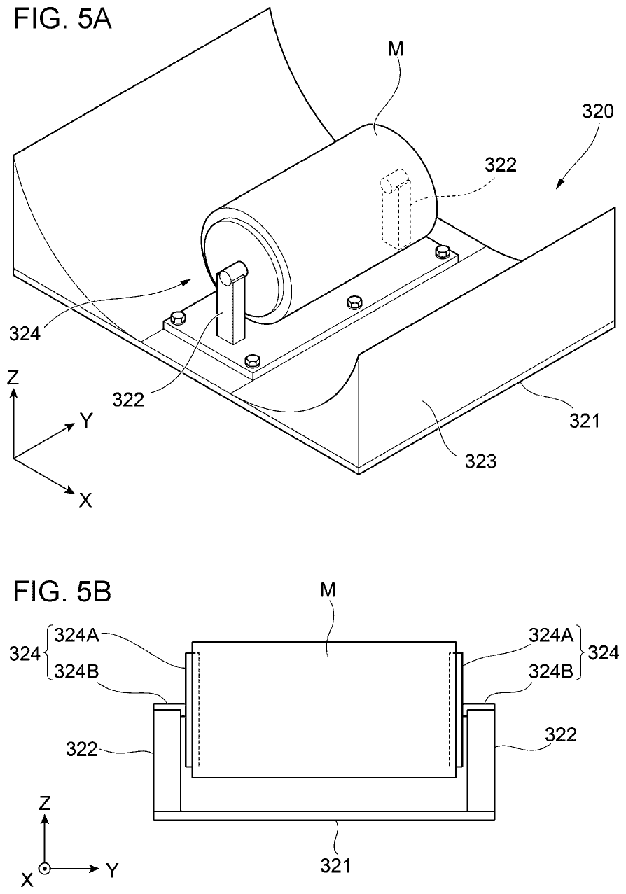

FIGS. 5A and 5B illustrate an example of attachment of the recording medium M to the jig 320 in the first exemplary embodiment. FIG. 5A is a perspective view illustrating an attachment state of the recording medium M, and FIG. 5B is a side view illustrating the attachment state of the recording medium M. Elements in FIGS. 5A and 5B corresponding to those in FIG. 4 are denoted by corresponding numerals.

In FIG. 5B, the reflecting mirror 323 is omitted for convenience of description.

In the attachment example illustrated in FIGS. 5A and 5B, a jig 324 is attached to each of the left and right sides of the recording medium M having a cylindrical shape.

The jig 324 is used to rotatably attach the recording medium M to the support member 322. The jig 324 can be attached to and removed from the recording medium M.

The jig 324 includes a disk 324A and a cylindrical projection 324B. The disk 324A is fitted to an opening or a recess in the recording medium M and used. The projection 324B is attached to the central position of the disk 324A.

The projection 324B is rotatably supported by the groove provided in the upper end surface of the support member 322. The projection 324B is used as a rotation shaft when the recording medium M is rotated by the movement of the intermediate transfer belt 131 (see FIG. 2). Due to the rotation of the projection 324B, a toner image can be transferred to the outer peripheral surface of the recording medium M.

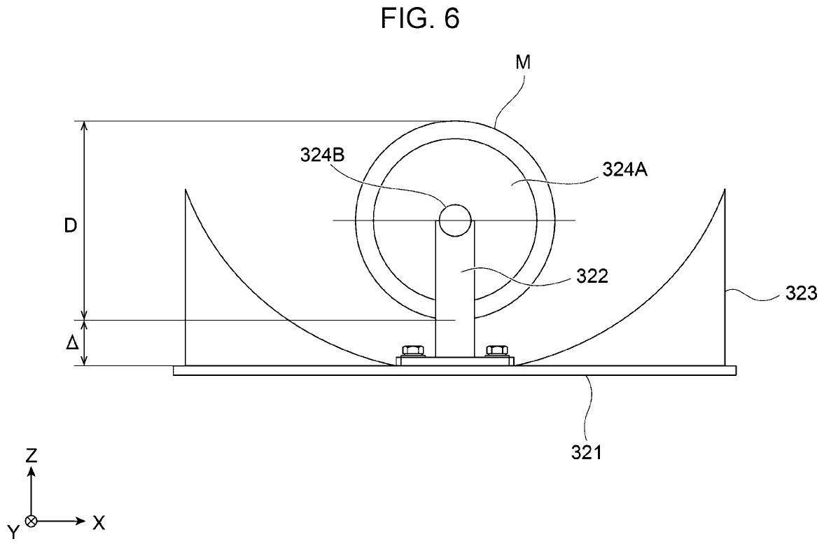

FIG. 6 illustrates the height relationship between the recording medium M in a state of being supported by the support member 322 and the reflecting mirror 323 (that is, the positional relationship in the Z-axis direction). Elements in FIG. 6 corresponding to those in FIGS. 5A and 5B are denoted by corresponding numerals.

As illustrated in FIG. 6, a gap is formed between the lowest point of the recording medium M in a state of being supported by the support member 322 and the upper surface of the base 321. That is, the recording medium M is supported in a state in which the recording medium M is not in contact with the base 321.

In the case of the present exemplary embodiment, the height of the gap Δ is designed to be approximately ⅓ or greater and ½ or less of the diameter D of the recording medium M. The height of the gap Δ is designed so that it is possible to irradiate the vicinity of the lowest point of the recording medium M with far-infrared rays reflected by the reflecting mirror 323. The design of the height of the gap Δ is related to the shape of the reflecting surface of the reflecting mirror 323, the disposition of the far-infrared unit 220 (see FIG. 3), and the like. In other words, the shape of the reflecting surface of the reflecting mirror 323, the disposition of the far-infrared unit 220, and the like are influenced by the height of the gap Δ.

In the case of the present exemplary embodiment, an upper end portion of the reflecting mirror 323 is located on the upper surface side of the recording medium M supported by the support member 322. However, the upper end portion of the reflecting mirror 323 is lower than the highest point of the recording medium M supported by the support member 322.

### Use Examples

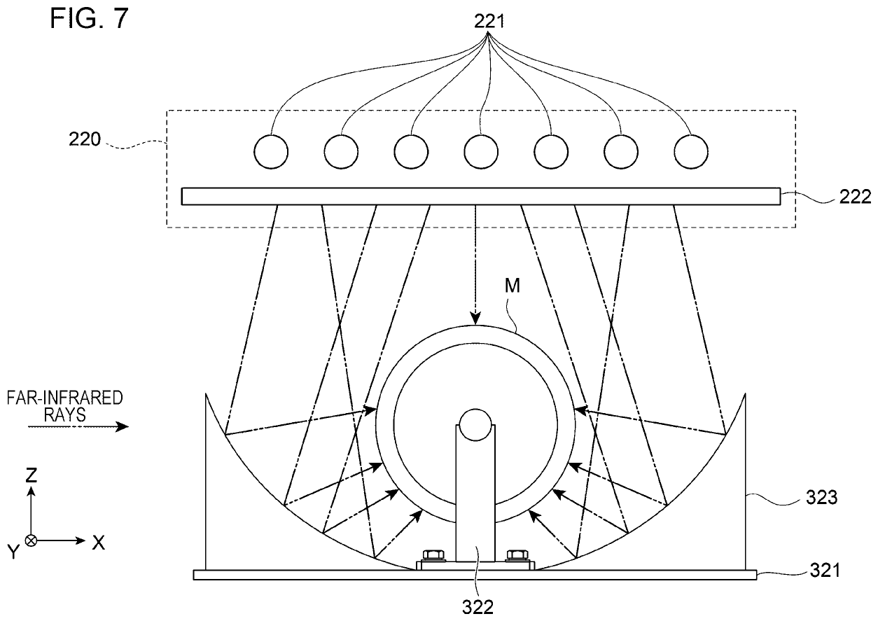

FIG. 7 illustrates the paths of far-infrared rays emitted from the far-infrared unit 220. Elements in FIG. 7 corresponding to those in FIGS. 3, 5A, and 5B are denoted by corresponding numerals.

Arrows in the figure represent the paths of far-infrared rays.

As illustrated in FIG. 7, far-infrared rays emitted from the far-infrared unit 220 are directly incident on the upper surface side of the recording medium M supported by the support member 322.

On the other hand, far-infrared rays reflected by the reflecting mirror 323 are incident on the side surface portion and the bottom surface side of the recording medium M.

Regarding the side surface portion here, the upper surface side and the lower surface side of the recording medium M are not strictly discriminated from each other. For example, the upper surface side of the recording medium M may be irradiated with far-infrared rays reflected by the reflecting mirror 323.

If the reflecting mirror 323 is not used, although the vicinity of the side surface of the recording medium M may be irradiated with far-infrared rays reflected by the base 321, the vicinity the lowest point of the recording medium M is not likely to be irradiated with far-infrared rays or may be irradiated with only a small amount of far-infrared rays. Therefore. the temperature of the lower surface side of the recording medium M does not rise and fixing failure occurs.

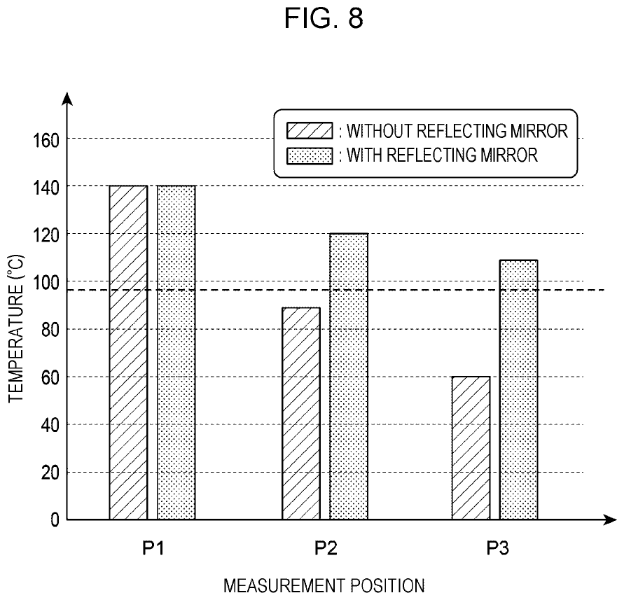

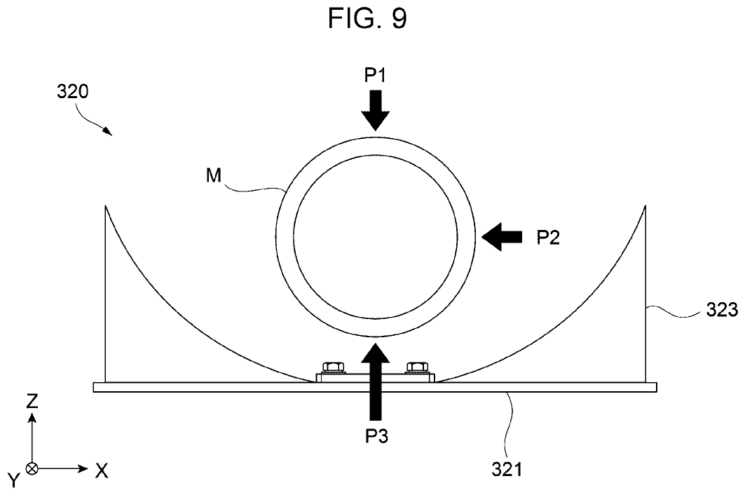

FIG. 8 is a graph representing temperatures measured at each measurement position of the recording medium M. FIG. 9 illustrates the measurement positions where the temperatures are measured.

In FIG. 8, the vertical axis represents the measured temperatures, and the horizontal axis represents the measurement positions. The broken line in FIG. 8 represents the lowest temperature at which a toner image can be fixed. Here, the lowest temperature is approximately 95° C.

P1 to P3 here correspond to the positions pointed by the arrows in FIG. 9. In FIG. 9, the support member 322 is omitted.

The measurement position P1 is the highest point of the recording medium M in a state of being supported by the jig 320, the measurement position P2 is in the vicinity of the side surface of the recording medium M in the state of being supported by the jig 320, and the measurement position P3 is the lowest point of the recording medium M in the state of being supported by the jig 320.

As illustrated in FIG. 8, the temperature of the recording medium M at the measurement position P1 is 140° C. in both of a case “without reflecting mirror” and a case “with reflecting mirror”. Since the lowest temperature at which a toner image can be fixed is about 95° C., no problem occurs in fixing of the toner image.

On the other hand, at the measurement position P2 and the measurement position P3, a temperature measured “without reflecting mirror” differs from a temperature measured “with reflecting mirror”.

For example, a temperature measured at the measurement position P2 is about 90° C. in the case “without reflecting mirror” and is about 120° C. in the case “with reflecting mirror”.

A temperature measured at the measurement position P3 is about 60° C. in the case of “without reflecting mirror” and is about 110° C. in the case of “with reflecting mirror”.

This has a meaning that, due to the use of the reflecting mirror 323, the amount of far-infrared rays with which the vicinity of the lowest point of the recording medium M is irradiated exceeds a threshold that is necessary for a temperature increase required to fix a toner image.

### Brief Summary

As described above, by using the jig 320 equipped with the reflecting mirror 323, without providing a mechanism for rotating the recording medium M in the fixing device 20 or in the jig 320, it is possible to reduce fixing failure of a toner image transferred to the recording medium M.

In the case of the present exemplary embodiment, the jig 324 (see FIGS. 5A and 5B) is rotatably supported by the support member 322 (see FIGS. 5A and 5B). Therefore, by attaching the recording medium M, to which the jig 324 is attached, to the jig 320 and transporting the recording medium M into the inlet/outlet chamber 30 (see FIG. 1), it becomes possible to transfer a toner image in the transfer device 10 (see FIG. 1).

### Second Exemplary Embodiment

In the present exemplary embodiment, the support member 322 (see FIG. 4) has a height-adjustable structure.

Also in the case of the present exemplary embodiment, the image forming system 1 (see FIG. 1) described in the first exemplary embodiment is used.

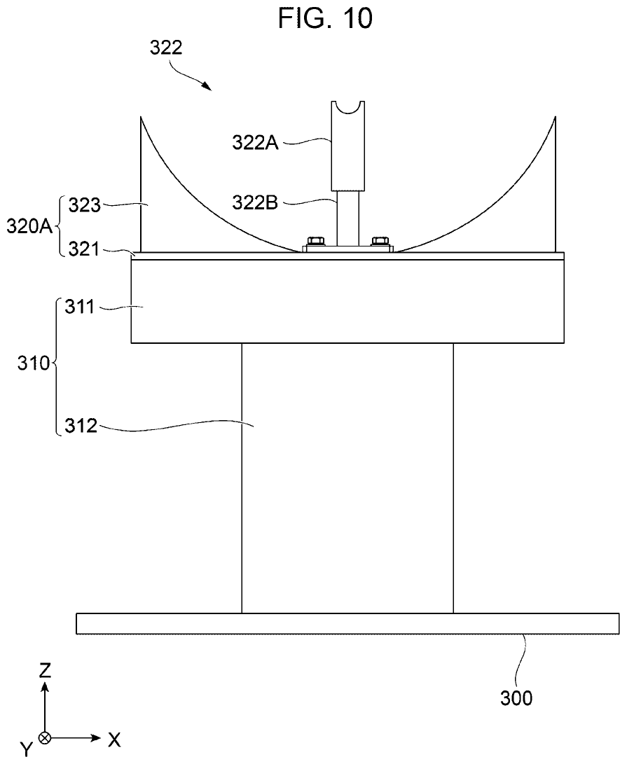

FIG. 10 illustrates an example of a jig 320A used in a second exemplary embodiment. Elements in FIG. 10 corresponding to those in FIG. 4 are denoted by corresponding numerals. The jig 320A is also an example of a holding device.

The support member 322 of the jig 320A illustrated in FIG. 10 includes two members 322A and 322B. The member 322B is fixed to the base 321, and the member 322A has a structure that allows the height of the member 322A to be adjustable with respect to the member 322B. For example, a structure such that plural holes having different heights in the Z-axis direction are formed in each of the member 322A and the member 322B may be used. In this case, the height of the uppermost end of the member 322A is adjustable by changing the height of a hole into which a pin (not shown) is inserted.

For another example, a structure such that a helical projection and a helical groove are formed on/in an inner peripheral surface of the member 322A and an outer peripheral surface of the member 322B may be used. In this case, the height of the uppermost end of the member 322A is adjustable by rotating the member 322A relative to the member 322B.

However, if the member 322A is made of only one component, depending on the rotation amount of the member 322A, the orientation of the groove in the upper end surface does not coincide with the orientation of the projection 324B (see FIG. 5B) of the jig 324 (see FIGS. 5A and 5B). For this reason, the member 322A includes two components so that the orientation of one of the components on the upper side can be changed relative to the orientation of the other component on the lower side. Thus, no matter how the height is adjusted, it is possible to cause the orientation of the substantially U-shaped groove formed at the uppermost end to coincide with the orientation of the projection 324B of the jig 324.

### Brief Summary

In the case of the first exemplary embodiment, the height of the support member 322 is designed in accordance with the diameter of the recording medium M to be supported, the curved-surface shape of the reflecting mirror 323, and the like. Therefore, if fixing failure is found in an inspection after fixing, it is necessary to replace the jig 320 with another jig 320 that differs in the height of support member 322.

However, in the case of the jig 320A described in the present exemplary embodiment, the height of the support member 322 is adjustable.

Therefore, even if fixing failure is found in an inspection after fixing, it is possible to adjust the height of the support member 322 on the spot. As a result, it is possible to reduce fixing failure with a simple operation.

Although it is necessary to prepare jigs 320 corresponding to the diameters of the recording media M in the case of the jig 320 described in the first exemplary embodiment, the jig 320A described in the present exemplary embodiment can be used for plural types of recording media M having different diameters.

### Other Exemplary Embodiments

(1) The technological scope of the present disclosure is not limited to the exemplary embodiments of the present disclosure that have been described above. It is clear from the description of the claims that the technological scope of the present disclosure includes various modifications and improvements made to the exemplary embodiments described above.

(2) Although it is assumed that an aluminum can, a steel can, or the like is an example of the recording medium M in the exemplary embodiments described above, the material of the recording medium M is not limited to a metal and may be, for example, glass, a tile, or ceramics.

(3) Although a case where the recording medium M has a substantially cylindrical shape has been described in the exemplary embodiments above, the shape of the recording medium M may be a sphere, a frustum, a box, or a polyhedron. When the recording medium M has a shape other than a substantially cylindrical shape, the reflecting surface of the reflecting mirror 323 (see FIG. 4) may be designed on the assumption that a surface that is directly irradiated with far-infrared rays is the “upper surface” and a surface that is not directly irradiated with far-infrared rays is the “lower surface”.

(4) Although the height of the gap Δ formed between the recording medium M in a supported state and the base 321 is approximately ⅓ or greater of the diameter D of the recording medium M in the exemplary embodiments above, it is sufficient that the temperature of the vicinity of the lowest point of the recording medium M in the supported state can be increased to a temperature necessary to fix a toner image or higher. For example, the height of the gap Δ may be ¼ or greater of the diameter D.

(5) Although a case where the upper end portion of the reflecting mirror 323 is located on the upper surface side of the recording medium M has been described in the exemplary embodiments above, the upper end portion of the reflecting mirror 323 may be located on the lower surface side of the recording medium M. Depending on the type or the use of the recording medium M, the upper end portion of the reflecting mirror 323 may be located above the highest point of the recording medium M.

(6) Although a case where the support member 322 (see FIG. 4) rotatably supports the recording medium M has been described in the exemplary embodiments above, the recording medium M may be unrotatable relative to the support member 322 if a toner image can be transferred without rotating the recording medium M or if the fixing device 20 (see FIG. 1) is used independently.

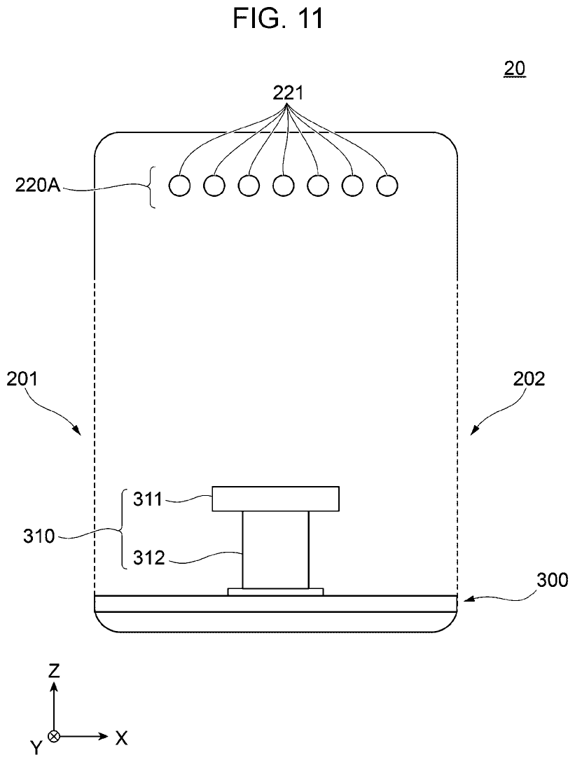

(7) Although a case where the far-infrared unit 220 (see FIG. 3) is used as a light source has been described in the exemplary embodiments above, an infrared unit 220A may be used as illustrated in FIG. 11. FIG. 11 illustrates another configuration example of the fixing device 20. Elements in FIG. 11 corresponding to those in FIG. 3 are denoted by corresponding numerals. As illustrated in FIG. 11, the black plate 222 (see FIG. 3) is not provided in the infrared unit 222A.

(8) Although a case where an opening is formed in the upper surface of the inlet/outlet chamber 30 (see FIG. 1) and the recording medium M is transported in and out through the opening has been described in the exemplary embodiments above, the opening may be formed in a side surface of the inlet/outlet chamber 30.

(9) Although a case where the transport mechanism 310 (see FIG. 3) is moved along the transport rail 300 (see FIG. 3) has been described in the exemplary embodiments above, the transport mechanism 310 may be moved by using a belt conveyor.

(10) Although a case where the recording medium M is transported into and out of the image forming system 1 (see FIG. 1) through the same position has been described in the exemplary embodiments above, the recording medium M may be transported into and out of the image forming system 1 through different positions.

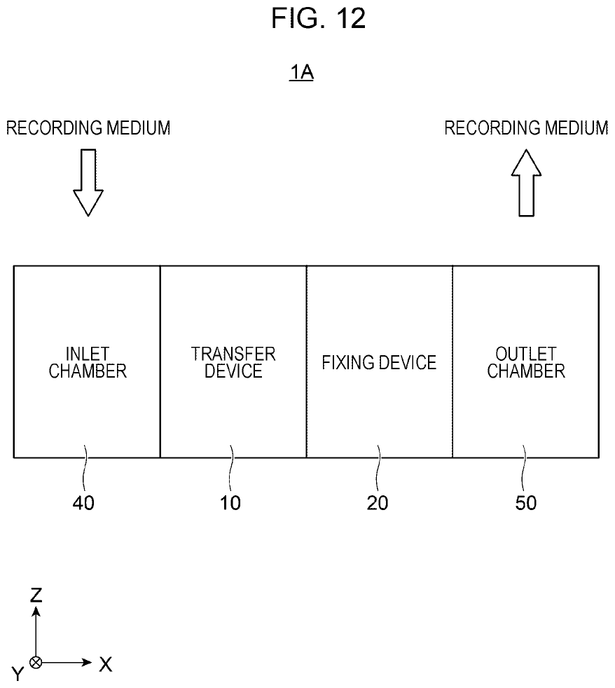

FIG. 12 illustrates a schematic configuration of an image forming system 1A according to another exemplary embodiment. Elements in FIG. 12 corresponding to those in FIG. 1 are denoted by corresponding numerals.

In the image forming system 1A illustrated in FIG. 12, an inlet chamber 40 and an outlet chamber 50 are used instead of the inlet/outlet chamber 30 (see FIG. 1).

In a case of the image forming system 1A illustrated in FIG. 12, the recording medium M transported into the inlet chamber 40 is first transported to the transfer device 10 adjacent to the inlet chamber 40. The recording medium M to which a toner image has been transferred in the transfer device 10 is transported to the outlet chamber 50 through the fixing device 20 and transported to the outside. In this case, the recording medium M is moved in only one dimension.

(11) Although the image forming system 1 (see FIG. 1) includes a combination of the fixing device 20, the transfer device 10, and the like in the exemplary embodiments above, only the fixing device 20 may be used independently.

(12) In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### Appendix

(((1)))

A holding device comprising: a base; a support member that is attached to the base and supports an object having a three-dimensional shape, to which a toner image has been transferred, in a state in which the object is not in contact with an upper surface of the base; and a reflecting member that is attached to the base, that reflects light emitted from a light source provided above the object in a state of being supported by the support member, and that irradiates at least a lower surface side of the object.

(((2)))

The holding device according to (((1))), wherein an upper end portion of the reflecting member is lower than a highest point of the object in a state of being supported by the support member.

(((3)))

The holding device according to (((1))) or (((2))), wherein the upper end portion of the reflecting member is located on an upper surface side of the object in a state of being supported by the support member.

(((4)))

The holding device according to any one of (((1))) to (((3))), wherein the support member supports the object in such a way that a height of a gap formed between a lowest point of the object in a state of being supported by the support member and the base is approximately ⅓ or greater of a height of the object.

(((5)))

The holding device according to any one of (((1))) to (((4))), wherein the support member supports the object in such a way that the object in a state of being supported by the support member is rotated by a transfer belt, for transferring a toner image, when the object is in contact with the transfer belt.

(((6)))

The holding device according to any one of (((1))) to (((4))), wherein the support member allows a height of a position at which the support member supports the object to be adjustable.

(((7)))

A fixing device comprising: a light source that generates light for heating toner transferred to an object having a three-dimensional shape; and a holding device that holds the object, wherein the holding device includes the holding device according to any one of (((1))) to (((5))).

(((8)))

An image forming system comprising: a transport mechanism that transports a holding device holding an object having a three-dimensional shape; a transfer device that transfers a toner image to the object in a state of being supported by the holding device; and a fixing device that fixes the toner image in a state in which the object to which the toner image has been transferred is held by the holding device, wherein the holding device includes the holding device according to any one of (((1))) to (((5))).

What is claimed is:

1. A holding device comprising:
a base;
a support member that is attached to the base and supports an object having a three-dimensional shape, to which a toner image has been transferred, in a state in which the object is not in contact with an upper surface of the base; and
a reflecting member that is attached to the base, that reflects light emitted from a light source provided above the object in a state of being supported by the support member, and that irradiates at least a lower surface side of the object.

2. The holding device according to claim 1,
wherein an upper end portion of the reflecting member is lower than a highest point of the object in a state of being supported by the support member.

3. The holding device according to claim 2,
wherein the upper end portion of the reflecting member is located on an upper surface side of the object in a state of being supported by the support member.

4. The holding device according to claim 1,
wherein the support member supports the object in such a way that a height of a gap formed between a lowest point of the object in a state of being supported by the support member and the base is approximately ⅓ or greater of a height of the object.

5. The holding device according to claim 1,
wherein the support member supports the object in such a way that the object in a state of being supported by the support member is rotated by a transfer belt, for transferring a toner image, when the object is in contact with the transfer belt.

6. The holding device according to claim 1,
wherein the support member allows a height of a position at which the support member supports the object to be adjustable.

7. A fixing device comprising:
a light source that generates light for heating toner transferred to an object having a three-dimensional shape; and
a holding device that holds the object,
wherein the holding device includes the holding device according to claim 1.

8. A fixing device comprising:
a light source that generates light for heating toner transferred to an object having a three-dimensional shape; and
a holding device that holds the object,
wherein the holding device includes the holding device according to claim 2.

9. A fixing device comprising:
a light source that generates light for heating toner transferred to an object having a three-dimensional shape; and
a holding device that holds the object,
wherein the holding device includes the holding device according to claim 3.

10. A fixing device comprising:
a light source that generates light for heating toner transferred to an object having a three-dimensional shape; and
a holding device that holds the object,
wherein the holding device includes the holding device according to claim 4.

11. A fixing device comprising:
a light source that generates light for heating toner transferred to an object having a three-dimensional shape; and
a holding device that holds the object,
wherein the holding device includes the holding device according to claim 5.

12. An image forming system comprising:
a transport mechanism that transports a holding device holding an object having a three-dimensional shape;
a transfer device that transfers a toner image to the object in a state of being supported by the holding device; and
a fixing device that fixes the toner image in a state in which the object to which the toner image has been transferred is held by the holding device,
wherein the holding device includes the holding device according to claim 1.

13. An image forming system comprising:
a transport mechanism that transports a holding device holding an object having a three-dimensional shape;
a transfer device that transfers a toner image to the object in a state of being supported by the holding device; and
a fixing device that fixes the toner image in a state in which the object to which the toner image has been transferred is held by the holding device,
wherein the holding device includes the holding device according to claim 2.

14. An image forming system comprising:
a transport mechanism that transports a holding device holding an object having a three-dimensional shape;
a transfer device that transfers a toner image to the object in a state of being supported by the holding device; and
a fixing device that fixes the toner image in a state in which the object to which the toner image has been transferred is held by the holding device,
wherein the holding device includes the holding device according to claim 3.

15. An image forming system comprising:
a transport mechanism that transports a holding device holding an object having a three-dimensional shape;
a transfer device that transfers a toner image to the object in a state of being supported by the holding device; and
a fixing device that fixes the toner image in a state in which the object to which the toner image has been transferred is held by the holding device,
wherein the holding device includes the holding device according to claim 4.

16. An image forming system comprising:
a transport mechanism that transports a holding device holding an object having a three-dimensional shape;
a transfer device that transfers a toner image to the object in a state of being supported by the holding device; and
a fixing device that fixes the toner image in a state in which the object to which the toner image has been transferred is held by the holding device.
wherein the holding device includes the holding device according to claim 5.
